(19) United States
(12) Patent Application Publication
(10) Pub. No.: US 2008/0023046 A1
(43) Pub. Date: Jan. 31, 2008

(54) Apparatus for the separation of a resin from a reaction mixture

(76) Inventors: Ermenegildo Restelli, Gerenzano (VA) (IT); Espedito Forace, San Donato (IT); Alfio Messina, Lodi (IT); Antonio Ferreri, Castellanza (VA) (IT)

Correspondence Address: KENYON & KENYON LLP, ONE BROADWAY, NEW YORK, NY, 10004, US

(21) Appl. No.: 11/827,164

(22) Filed: Jul. 10, 2007

Related U.S. Application Data
(60) Provisional application No. 60/819,951, filed on Jul. 10, 2006.
(60) Provisional application No. 60/834,606, filed on Jul. 31, 2006.
(60) Provisional application No. 60/847,805, filed on Sep. 27, 2006.

(51) Int. Cl. B01D 11/02

(52) U.S. Cl. 134/33; 422/272

(57) ABSTRACT

An apparatus is provided for the separation of a resin from a reaction mixture. The apparatus comprises a column fitted with a side port, two inlet/outlet ports, and two flanges. Each flange is fitted with a multilayer net screen supported by a support grid. The column itself is attached to a support structure. A process is provided for using this apparatus to remove a resin from a reaction mixture, wherein the reaction mixture is added to the apparatus and the resin is filtered off, remaining in the column as the waste leaves. The remaining resin is then washed and eluted to provide a purified product.

### CROSS-REFERENCE TO RELATED APPLICATIONS

This application claims the benefit of U.S. Provisional Application No. 60/819,951 (filed Jul. 10, 2006), U.S. Provisional Application No. 60/834,606 (filed Jul. 31, 2006), and U.S. Provisional Application No. 60/847,805 (filed Sep. 27, 2006). Each of these aforementioned applications are incorporated herein by reference in their entireties.

### FIELD OF THE INVENTION

The invention encompasses an apparatus for the separation of a resin from a reaction mixture, particularly from a fermentation broth, and a process for separating a resin from a reaction mixture using this apparatus.

### BACKGROUND OF THE INVENTION

The separation of the product from a reaction mixture can be, at times, very complicated and tedious leading to low yields of the product, and sometimes also to low purity. This problem is demonstrated, for example, when solids are present in the reaction mixture having a different nature that complicates the separation of the product from them. Another example is fermentation processes, wherein a biological agent, such as microorganisms, is grown on a substance, either organic or inorganic, and during or after such growth, the biological agent produces, among others, organic substances that are of interest. Typically, the resulting fermented broth is filtered to remove the exhaust biological mass (i.e., microbial cells), and the resulting clear filtrate is treated, in batch or in a chromatographic column, with a resin which binds the particular product of interest. The resin is then washed to remove the unwanted impurities, and the desired product is eluted with a suitable solvent mixture. Synthetic and natural resins are used extensively for the recovery and the purification of fermentation products during the downstream processes.

Recently, the above approach has been implemented by the addition of resins either during the fermentation or into the harvest broth before filtration, as disclosed in Journal Ind. Microbiol. 5:283-288, Journal of Industrial Microbiology 1996, 16, 305-308, J. Antibiot. 55:141-146, Biotechnology and Bioengineering, 78(3):280-288, (2002), Letters in Applied Microbiology 2003, 37, 196-200, US Patent application US 2005/0170475 A1, and in J. Nat. Prod. 2002, 65, 570-572.

This approach has several advantages, for example, it can increase the productivity of the fermentation and/or improve the product stability, and/or increase the extraction yield.

In such processes, there is a concern regarding the separation of the resin from the reaction mixture, for example, a whole fermentation broth, which poses serious technological issues, especially when the process is conducted on an industrial scale.

A known apparatus for separating a resin from the reaction mixture is “Expanded Bed Adsorption,” supplied by Amersham Biosciences now part of GE Healthcare group, which is a unit operation that uses STREAMLINE™ adsorbents and columns for recovering proteins directly from crude feedstock. However, Expanded Bed Adsorption (“EBA”) technique is used mostly for the primary capture of proteins.

In J. Antibiot. 55:141-146, (2002) a 8.9X33 cm column was used for capturing the product.

In Biotechnology and Bioengineering, 78(3):280-288, (2002), only small samples of the fermentation broth were treated, and not the entire broth. In these samples the resin was settled by gravity and the culture broth containing cells was decanted.

In Letters in Applied Microbiology 2003, 37, 196-200, the culture samples containing mycelium and the resin were separated by centrifugation at 1670 g for 10 min and the culture supernatant was discarded.

US Patent application US 2005/0170475 A1 discloses the treatment of one liter of fermentation broth by stirring with 10 grams of XAD16 beads for six hours. The mixture was then centrifuged and the supernatant was removed.

J. Nat. Prod. 2002, 65, 570-572 discloses the collection of twenty liters of XAD16 resin from a 1000 L fermentation using a wire-mesh filter basket.

There is a need in the art for more apparatus that separate resins from a reaction mixture, in particular, from whole fermentation broths.

### SUMMARY OF THE INVENTION

In one embodiment, the present invention provides an apparatus for the separation of a resin from a reaction mixture, wherein the apparatus is a rotating cylindrical column having a side port, and two flanges, one at either end of the column, that are each fitted with a multilayer net screen supported by a support grid.

In another embodiment, the present invention provides a process for separating a resin from a reaction mixture comprising loading the column with a reaction mixture, filtering off the resin from the reaction mixture, washing the resin, and eluting the product from the resin, wherein the resin remains in the column during the entire process.

### BRIEF DESCRIPTION OF THE DRAWINGS

FIG. 1 is a schematic diagram of a side view of one embodiment of the apparatus of the present invention in a vertical position.

FIG. 2 is a schematic diagram of a side view of one embodiment of the apparatus of the present invention in a horizontal position during the filtration of resin from a reaction mixture.

FIG. 3 is a schematic diagram of a side view of one embodiment of the apparatus of the present invention in a vertical position during the washing of the resin.

FIG. 4 is a schematic diagram of a side view of one embodiment of the apparatus of the present invention in a vertical position during the elution of a product from the resin.

### DETAILED DESCRIPTION OF THE INVENTION

The apparatus of the present invention allows for the separation of the resin from the reaction mixture while avoiding physical contact of the operator with the resin, i.e., manual removal of the resin from the reaction mixture. Also, this apparatus allows for the performance of the elution of the product from the resin without having to remove the resin manually from the filter, and place it in a column for the elution step. Hence, this apparatus is preferably desirable when performing reactions on a large scale. Moreover, this apparatus is especially advantageous when the product is potent, thus avoiding contact of the product with the environment, a factor which is also desired from the operator point of view.

The present invention provides an apparatus for the separation of a resin from a reaction mixture, wherein the apparatus is a rotating cylindrical column having a side port, and two flanges, one at either end of the column, that are each fitted with a multilayer net screen supported by a support grid. Preferably, the reaction mixture is a fermentation broth or a mixture from a solid phase chemical synthesis. Preferably, the resin is a polymeric adsorbent resin. Most preferably, the resin is a polystyrene/divinylbenzene adsorbent resin (e.g., Amberlite XAD16, Amberlite XAD4, Diaion HP20, Amberlite XAD1600, Amberlite XAD1180, Diaion HP21, Sepabeads SP825, Sepabeads SP850, Sepabeads SP70, Sepabeads SP700 or Sepabeads SP207) or a polyacrylic adsorbent resin (e.g., Amberlite XAD7 or Diaion HP2MG). Amberlite XAD is a trademark of Rohm and Haas Co., and Diaion and Sepabeads resins are supplied by Mitsubishi Chemical. There are also other suppliers of these types of resins. Alternatively, a resin that works with a different adsorption interaction (e.g., ion exchange, affinity, metal affinity, hydrophobic interaction, etc.) may be used.

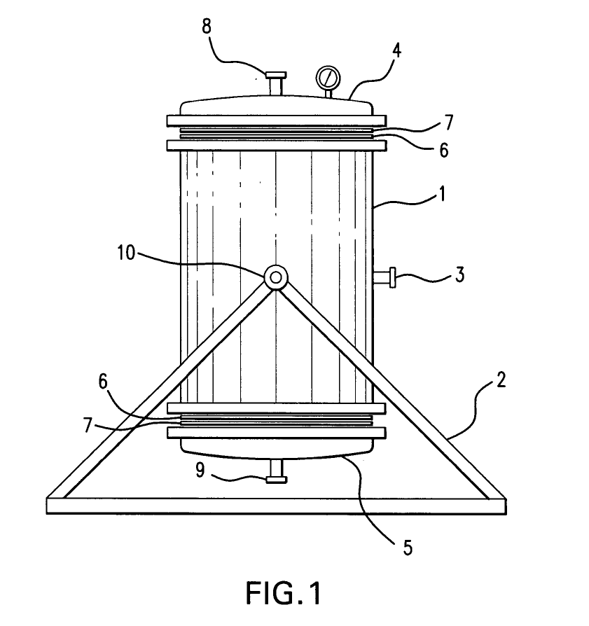

A preferred embodiment of the apparatus of the present invention will now be described with reference to FIG. 1. The following embodiments are not intended to limit the scope of the invention, and it will be recognized by those of skill in the art that there are other embodiments within the scope of the invention.

As set forth in FIG. 1, the apparatus comprises a cylindrical column 1 attached to a support structure 2, such that the cylindrical column 1 is rotatable around its horizontal (i.e., radial) axis by at least one point(s) of attachment 10 to the support structure 2. The column 1 is preferably an empty chromatographic column. The support structure 2 may be any shape or size, and may be fixed or mobile (e.g., mounted on wheels), providing that it permits the column 1 to rotate. The at least one point of attachment 10 may include any means that permits rotation of the column 1 around its radial axis. Although, consistent with the invention, the column 1 may be mounted to the support structure 2 by at least one point of attachment 10, there are preferably two points of attachment 10, one on either side of the column 1, and these points of attachment 10 are preferably located in the middle of the column 1, and are preferably positioned diametrically opposite each other. Preferably, the two points of attachment 10 each include a shaft welded in the middle of the outside wall of the column 1, perpendicular to the column 1, wherein the points of attachment 10 are on opposite sides of the column 1. Preferably, the shafts are in contact with the support structure 2 through a bearing system, permitting rotation of the column 1, and one shaft is connected to an air-driven motor to facilitate the rotation. The cylindrical column 1 includes a side port 3, and two flanges 4/5, which may be referred to as a top flange 4 and a bottom flange 5, wherein the top flange 4 is located at a higher vertical position than the bottom flange 5 when the column 1 is in a vertical position. The flanges 4/5 are each fitted with a net screen 6, which is preferably multilayered, and supported by a support grid 7. The side port 3 is preferably positioned approximately in the center of a longitudinal part of the cylinder and preferably communicates with the internal part of the cylinder. In addition, the ends of the cylindrical column 1 are connected on each side of the column to inlet/outlet ports 8 and 9. The size of the column 1 may be varied according to the amount of resin to be filtered and the difficulty of the separation, and one of skill in the art will be able to determine an appropriate column size.

Optionally, the column 1 could be jacketed when the required operating temperature is different from the environmental temperature.

Preferably, the mesh size of the net screens 6 are defined so that the resin and the attached product are retained inside the column 1 while the rest of the reaction mixture (e.g., insoluble waste including, in the case of a fermentation reaction, microbial cells, insoluble and/or unused components of the reaction mixture) is filtered out. Preferably, additional ports and connections are present, which are not shown in the figures, on either one, or both of the flanges 4/5 to allow the flow of processing fluids and for the installation of instrumentation, such as a manometer and/or thermometer.

Preferably, parts 1-5, and 7-10 of the apparatus presented in FIG. 1 are made from a material selected from the group consisting of metal alloy, plastic, glass and a glass-lined material, wherein the material is chosen according to the solvents used in the washing and elution processes. More preferably, the material is a metal alloy, and, most preferably, stainless steel. Preferably, the net screens 6 are made from either metal alloy or plastic. Preferably, any gaskets or O-rings are made of material compatible with the solvents used. Preferably, the material is polytetrafluoroethylene (PTFE).

The flanges 4/5 are used to stabilize the system. Hence, they can have any desired shape as long as the column 1 is supported.

The present invention provides a process for separating a resin from a reaction mixture comprising loading the column with a reaction mixture, filtering off the resin and an attached product from the reaction mixture, washing the resin and the attached product, and eluting the product from the resin, wherein the resin remains in the column during the entire process (i.e., during the steps of filtering, washing, and eluting).

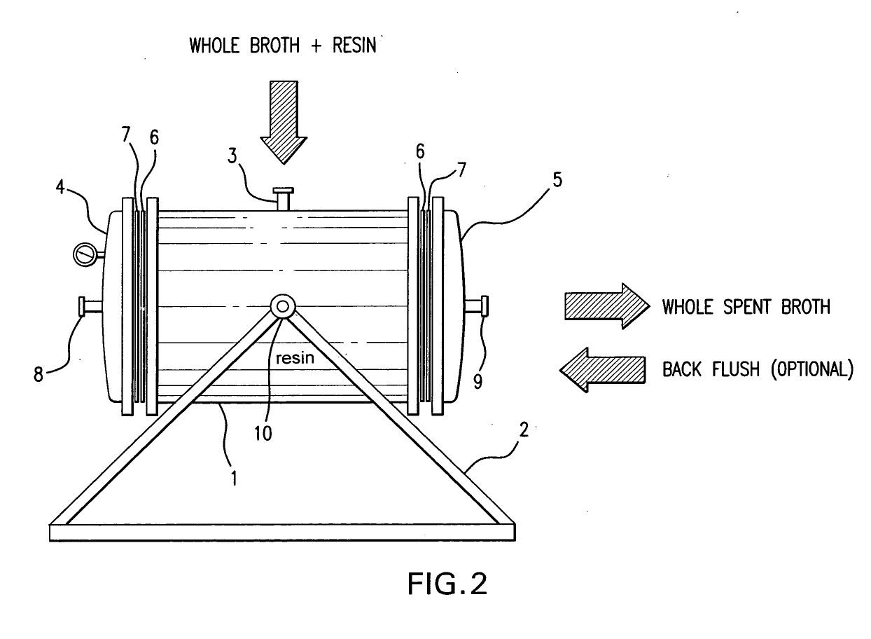

A preferred embodiment of the process of the present invention—in particular, a preferred embodiment of the process as applied to a reaction mixture from a fermentation broth—will now be described with reference to FIGS. 2-4. The following embodiments are not intended to limit the scope of the invention, and it will be recognized by those of skill in the art that there are other embodiments within the scope of the invention.

As set forth in FIGS. 2-4, a process is provided for separating a resin from a reaction mixture comprising loading the column 1 with a reaction mixture, filtering off the resin from the reaction mixture, washing the resin, and eluting the product from the resin, wherein the resin remains in the column 1 during the entire process. The product may be attached to the resin by any mechanism, including, but not limited to, absorption, adsorption, ionic interaction, affinity interaction, and hydrophobic interaction. Preferably, the product is selected from the group consisting of macrolides (particularly poliketide macrolactone), polypeptides, glycopeptides, nucleotides and anthracyclines. More preferably, the product is selected from the group consisting of Epothilone (particularly Epothilone D), Mitomycin, Cyclosporin, Bleomycin, Daunorubicin, and Fludarabine. Most preferably, the product is Epothilone D.

Preferably, the reaction mixture is loaded through the side port 3 of the column 1, while maintaining the column 1 in a horizontal position, as set forth in FIG. 2. Preferably, the resin is then filtered off, while still maintaining the column 1 in a horizontal position by remaining in the column 1 while the waste of the reaction mixture is pushed out of the column 1 via at least one of the inlet/outlet ports 8/9. Preferably the waste is pushed out by gravity, but pressure, vacuum, or a combination of any of these may be used as well. Pressure and/or vacuum may be applied to the column 1 by attaching a pump, or other pressure inducing equipment, to either, or both, of the inlet/outlet ports 8/9, and/or the side port 3. Alternatively, pressure and/or vacuum may be applied to the column 1 through an additional port or connection on either, or both, of the flanges 4/5.

The waste may be biomass or any other component which is undesired and can be excluded by the filtration process. The biomass may contain microbial cells, insoluble and/or unused components of the fermentation media (e.g., flour, starch, calcium carbonate, etc.). Preferably, the waste departs from the column 1 through one of the inlet/outlet ports 8/9. Optionally, both inlet/outlet ports 8/9 can be used to remove the waste, hence doubling the filtration surface. Optionally, pressure or vacuum can be used to speed the filtration. Preferably, the net screen 6 can be cleaned by a back flush using waste reaction mixture or using a fresh solvent, in case of clogging, as depicted in FIG. 2. The solvent used for the back flush is preferably the same solvent used for washing.

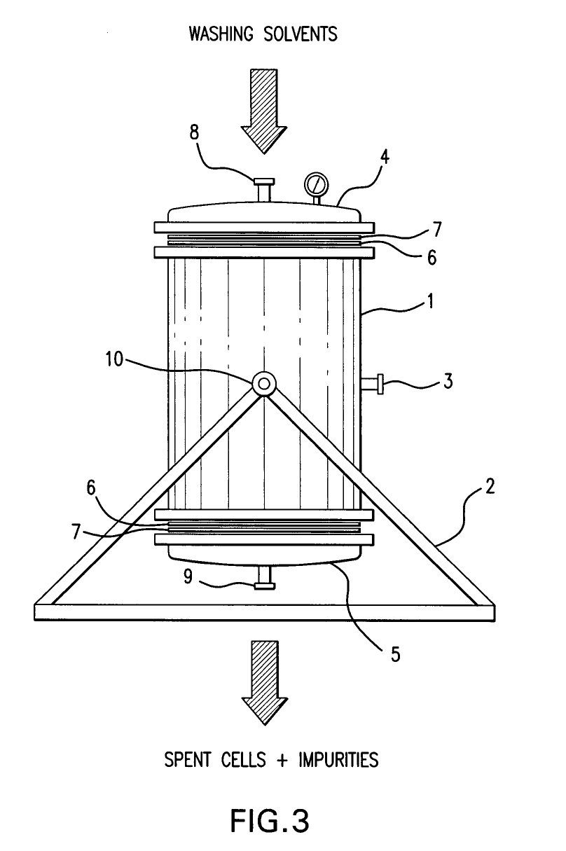

Washing the resin and the attached product is done by adding a solvent to the column 1. The solvent may be added via either side port 3 or either of the inlet/outlet ports 8/9. Preferably, washing includes moving the column 1 to a vertical position, as shown in FIG. 3, before the addition of the solvent to the column 1. Preferably, the solvent is selected from the group consisting of water, acidic water (e.g., aqueous mineral acids, such as hydrochloric acid and sulfuric acid, or aqueous organic acids, such as formic acid or acetic acid, etc.), basic water (e.g, aqueous hydroxide bases, such as sodium hydroxide and potassium hydroxide, or aqueous carbonate bases, such as sodium carbonate or potassium carbonate, etc.), buffer solution, organic solvents that are soluble or partially soluble in water or in the buffer solution, and mixtures thereof. Preferably, the organic solvent includes, but is not limited to acetone, methanol, ethanol, isopropanol, tetrahydrofuran, acetonitrile, dimethylformamide, dimethylsulfoxide, and/or ethyl acetate. Preferably, the organic solvent is methanol. Preferably, the solvent is water. Any buffer compatible with the stability and the solubility of the product can be used. Buffers include, but are not limited to acetates, carbonates, bicarbonates, phosphates, and ammonium compounds (e.g., sodium acetate or acetic acid). Preferably, the solvent is added from the uppermost inlet/outlet port 8, or from the bottommost inlet/outlet port 9 using pressure, as set forth in FIG. 3. Preferably, a minimal amount, or no product is detached from the resin during washing.

Preferably, washing is repeated to ensure the departure of the waste. Preferably, the column 1 may be rotated back and forth, i.e., horizontal to vertical and vice versa. The washing from the bottom allows for the suspension of the resin.

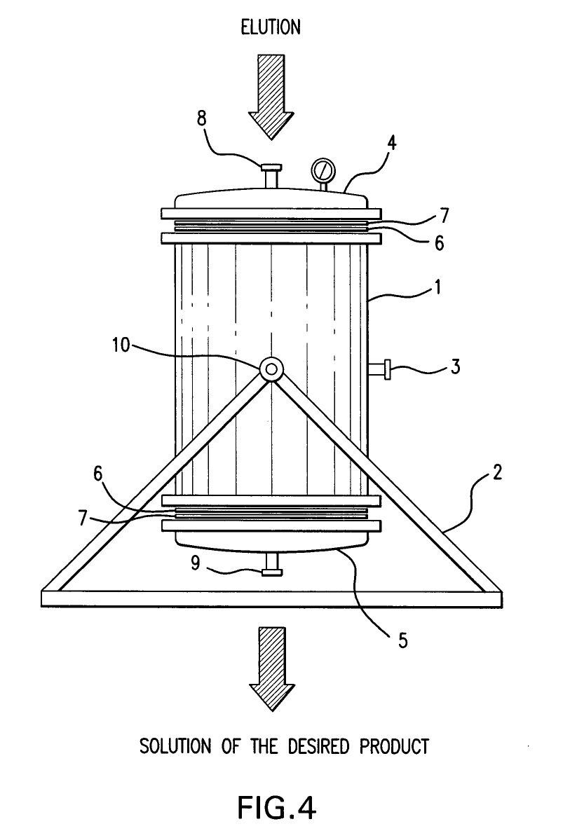

Preferably, elution of the product is done by placing the column 1 in a vertical position, and adding a suitable solvent through the top inlet/outlet port 8, as set forth in FIG. 4. Preferably, the solvent is selected from the group consisting of the same solvents that may be employed for the washing step (as described above), a water immiscible organic solvent, and mixtures thereof, provided that the solvent employed for elution is not identical, in composition and proportion, to the solvent employed for washing. For example, when the mixture of water and an organic solvent that is used in the washing step is also used for elution, the ratio of water to organic solvent is less for the elution step than for the washing step, such that the product may be eluted during the eluting step and not during the washing step. The particular ratios required will depend upon the product and the resin used, and may be readily determined through routine experimentation during process development by one of skill in the art. Water immiscible organic solvents include, but are not limited to toluene and dichloromethane. Preferably, the eluate containing the product is collected from the bottom inlet/outlet port 9.

Limitations on the various process parameters (temperature, pressure, time, etc.) of each step (filtering, washing, elution) are based upon the stability of the material used for the apparatus, as well as the stability of the resin and attached product. Such limitations will be readily apparent to one of skill in the art.

Having described the invention with reference to certain preferred embodiments, other embodiments will become apparent to one skilled in the art from consideration of the specification. The invention is further defined by reference to the following examples describing in detail the process and compositions of the invention. It will be apparent to those skilled in the art that many modifications, both to materials and methods, may be practiced without departing from the scope of the invention.

### EXAMPLES

### Example 1

### Separation of Resin from a Reaction Mixture Containing Epothilone

The production of Epothilone D was carried out by fermenting a Myxococcus xanthus strain in the presence of an adsorption resin, as described in Lau J, Frykman S, Regentin R, Ou S, Tsuruta H, Licari P, Optimizing the Heterologous Production of Epothilone D in Myxococcus xanthus, Biotechnology and Bioengineering, 78(3):281-288, (2002), which is incorporated herein by reference in its entirety. At the end of the fermentation process the resin was separated from the cells using the equipment described above, in the following manner:

8300 L of fermented broth containing 233.6 g of Epothilone D and 180 L of XAD16 (a styrene/divinylbenzene polymeric adsorbent resin available from Rohm & Haas Co.) were loaded to the column 1, with a height of 100 cm and an internal diameter of 60 cm, in horizontal position, through the side port 3. The filtration was performed in 2 hours. The column 1 was moved to the vertical position and the resin was washed with 800 L of purified water at a flow rate of 600 L/h, until no turbidity was observed. No activity was detected in the spent broth.

The product, Epothilone D, was then eluted from the resin using 2300 L of a 84:16 (v/v) Methanol/Water mixture, recovering 224.5 g of EPO D activity in a 96.1% yield. The solution obtained was submitted to the next steps of the purification process as reported in Arslanian R L, Parker C D, Wang P K, McIntire J R, Lau J, Starks C, Licari P J, Large-Scale Isolation and Crystallization of Epothilone D from Myxococcus xanthus Cultures, J. Nat. Products, 65:570-572 (2002), which is incorporated herein by reference in its entirety.

### Example 2

### Separation of Resin from a Reaction Mixture Containing Mitomycin

8100 L of harvest broth could be combined with 2000 L of methanol and with 200 L of XAD4 resin, and stirred for 16 hours at room temperature. The suspension could then be loaded to the column 1 in the horizontal position through the side port 3 to filter the resin. The column 1 could then be moved to the vertical position and washed with 1000 L of purified water in back flush. The product, Mitomycin, could then be eluted with methanol, and about 95% of the original activity contained in the harvest broth should be recovered, wherein the projected recovery is based upon the expected amount of product in the eluate divided by the amount of product in the harvest broth (original activity). The prophetic yields of the following examples are similarly determined.

### Example 3

### Separation of Resin from a Reaction Mixture Containing Mitomycin

7800 L of harvest broth could be combined with 2000 L of methanol and 180 L of XAD16 resin, and stirred for 16 hours at room temperature. The suspension could then be loaded to the column 1 in the horizontal position through the side port 3 to filter the resin. The column 1 could then be moved to the vertical position and washed with 1000 L of purified water in back flush. The product, Mitomycin, could then be eluted with methanol, and about 92% of the original activity contained in the harvest broth should be recovered.

### Example 4

### Separation of Resin from a Reaction Mixture Containing Mitomycin

The fermentation of Mitomycin could be carried out in the presence of 2% (w/v) of XAD7 resin. At the end of the fermentation process, the broth could then be loaded to the column 1 in the horizontal position, through the side port 3. The spent broth could then be eliminated while the resin was washed with purified water. The product, Mitomycin, should then be recovered using 6 column volumes of ethyl acetate in a 85% extraction yield.

### Example 5

### Separation of Resin from a Reaction Mixture Containing Cyclosporin

2850 L of Cyclosporine fermented broth could be combined with 350 L of methanol and 200 L of XAD16 resin, and stirred at room temperature for 16 hours. The suspension could then be loaded to the column 1 in the horizontal position, through the side port 3 to filter the resin. The column 1 could then be moved to the vertical position and washed with 1000 L of purified water in back flush. The product, Cyclosporin, could then be eluted with methanol, and about 85% of the original activity contained in the harvest broth should be recovered.

### Example 6

### Separation of Resin from a Reaction Mixture Containing Daunorubicin

At the end of fermentation process, 8500 L of Daunorubicin harvest broth could be treated at 30° C. in acidic conditions, under stirring, for 20 hours. The pH could then be brought to 6 with an NaOH solution and 200 L of HP20 resin could then be added and the suspension could then be stirred at room temperature for an additional 16 hours. The suspension could then be filtered, loading the column 1 in the horizontal position through the side port 3. The column 1 could then be moved to the vertical position and washed with 1000 L of purified water. The product, Daunorubicin, could then be eluted with acetone, and about 70% of the original activity contained in the harvest broth should be recovered.

### Example 7

### Separation of Resin from a Reaction Mixture Containing Bleomycin

The fermentation of Bleomycin could be carried out in the presence of 3% (w/v) of HP20 resin in a 10000 L fermentation tank. At the end of the fermentation process, the broth could then be loaded to the column 1 in the horizontal position, through the side port 3. The spent broth could then be eliminated while the resin was washed with purified water. The product, Bleomycin, should then be recovered using 7 column volumes of a 80:20 (v/v) purified water/acetone mixture in a 90% extraction yield.

### Example 8

### Separation of Resin from a Reaction Mixture Containing Fludarabine

In a 1000 L stainless steel reactor, 2400 g of 2 Fluoroadenine could be suspended in 400 L of a phosphate buffer/dimethylformamide 80:20 (v/v) mixture at a pH of 7. 6000 g of Arabinosyl Uracil (ARA-U) and 8400 g of E. Coli NP25 cell paste could then be added with 100 L of XAD16 resin. The suspension could then be stirred at 60° C. for 24 hours and then filtered using the column 1 in the horizontal position to eliminate the exhausted bacterial cells and the unbound by-products. The column 1 could then be moved to the vertical position and washed with 400 L of purified water. The product, Fludarabine, could then be eluted with a 90:10 (v/v) dimethylformamide/purified water mixture and precipitated by adding additional water to the extract.

We claim:

1. An apparatus for the separation of a resin from a reaction mixture comprising a rotating cylindrical column wherein each end of the cylindrical column is provided with a net screen.

2. The apparatus of claim 1 wherein the net screens at each end of the cylindrical column are fitted to a support grid.

3. The apparatus of claim 2 wherein each support grid is provided with a flange.

4. The apparatus of claim 3 wherein the net screen comprises multiple layers.

5. The apparatus of claim 4 wherein the column is rotatable about a radial axis.

6. The apparatus of claim 5 wherein the column is mounted to a support structure by at least one point of attachment, wherein the point of attachment permits rotation of the column around a radial axis.

7. The apparatus of claim 6 wherein the column is mounted to the support structure by two points of attachment wherein the points of attachment are positioned diametrically opposite each other to permit rotation of the column around a radial axis.

8. The apparatus of claim 7 wherein each of the two points of attachment is joined by a shaft welded onto an outside surface of the column, wherein each shaft is fitted to the support structure.

9. The apparatus of claim 8 wherein each of the shafts contact the support structure through a bearing system.

10. The apparatus of claim 9 wherein at least one shaft is connected to a motor.

11. The apparatus of claim 6 wherein the cylindrical column is provided with a side port that communicates with the internal part of the cylinder.

12. The apparatus of claim 11 wherein the side port is positioned on a longitudinal part of the cylinder.

13. The apparatus of claim 12 wherein the side port is positioned approximately in the center of the longitudinal part of the cylinder.

14. The apparatus of claim 11 wherein each flange is provided with at least one inlet/outlet port that communicates with the internal part of the cylinder.

15. The apparatus of claim 14 wherein the net screen or the multiple layers of the net screen forms a mesh size that allows the resin with an absorbed product to be retained inside the column while the remainder of the reaction mixture is allowed to pass through.

16. The apparatus of claim 15 wherein one or both of the flanges is provided with additional ports to allow for at least one of the flow of processing fluids and the installation of instrumentation.

17. The apparatus of claim 15, wherein the column is provided with an insulating layer.

18. The apparatus of claim 17 wherein the insulating layer is a jacket.

19. The apparatus of claim 15 wherein the column, the support structure, the side port, the inlet/outlet ports, the flanges, and the support grid are made of a material selected from the group consisting of metal alloy, plastic, glass-lined material, and glass.

20. The apparatus of claim 15, wherein the column, the support structure, the side port, the inlet/outlet ports, the flanges, and the support grid are made of a metal alloy.

21. The apparatus of claim 20, wherein the metal alloy is stainless steel.

22. A process for separating a resin from a reaction mixture comprising loading a column with a reaction mixture, filtering off the resin from the reaction mixture, washing the resin, and eluting a product from the resin, wherein the resin remains in the column during the entire process.

23. A process for separating a resin from a reaction mixture, comprising:
(a) loading a cylindrical column of an apparatus as defined in claim 15 with a reaction mixture containing a resin with an attached product;
(b) filtering the resin and the attached product from the reaction mixture so that a remaining reaction mixture is removed from the column as waste;
(c) washing the resin and the attached product with a first solvent; and
(d) eluting the attached product from the resin with a second solvent,
wherein the resin remains in the column during steps (b) through (d).

24. The process of claim 23, wherein the reaction mixture is loaded through the side port while the column is in a horizontal position.

25. The process of claim 23, wherein the filtration is conducted with the column in the horizontal position.

26. The process of claim 23, wherein the waste is removed from at least one inlet/outlet port.

27. The process of claim 26, wherein the waste is removed from two inlet/outlet ports.

28. The process of claim 23 wherein during the filtration step, pressure or vacuum is applied to the column to remove the waste.

29. The process of claim 23, wherein the washing step is performed while the column is in a vertical position by adding the first solvent through the uppermost inlet/outlet port.

30. The process of claim 23, wherein the washing step is performed while the column is in a vertical position by adding the first solvent through the bottommost inlet/outlet port.

31. The process of claim 23, wherein the first solvent is selected from the group consisting of water, acidic water, basic water, buffer solution, organic solvents, and mixtures thereof, provided that any organic solvent selected is soluble or partially soluble in water or any selected buffer solution.

32. The process of claim 31, wherein the organic solvent is selected from the group consisting of acetone, methanol, ethanol, isopropanol, tetrahydrofuran, acetonitrile, dimethylformamide, dimethylsulfoxide, ethyl acetate, and mixtures thereof.

33. The process of claim 32, wherein the organic solvent is methanol.

34. The process of claim 31, wherein the first solvent is water.

35. The process of claim 31, wherein the buffer solution is a solution comprising a buffer selected from the group consisting of acetates, carbonates, bicarbonates, phosphates, and ammonium compounds.

36. The process of claim 23, wherein the elution is performed while the column is in a vertical position by adding the second solvent through the uppermost inlet/outlet port.

37. The process of claim 31, wherein the second solvent is selected from the group consisting of the first solvent, a water immiscible organic solvent, and mixtures thereof.

38. The process of claim 37, wherein the water immiscible organic solvent is selected from the group consisting of toluene and dichloromethane.

39. The process of claim 23, wherein the attached product is selected from the group consisting of macrolides, polypeptides, glycopeptides, nucleotides and anthracyclines.

40. The process of claim 23, wherein the attached product is selected from the group consisting of Epothilone, Mitomycin, Cyclosporin, Daunorubicin, Bleomycin, and Fludarabine.
